(19) United States
(12) Patent Application Publication
(10) Pub. No.: US 2006/0026532 A1
(43) Pub. Date: Feb. 2, 2006

(54) Confirming an action utilizing a single button object

(75) Inventor: William G. Pagan, Durham, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/909,656

(22) Filed: Aug. 2, 2004

(51) Int. Cl. G06F 3/00

(52) U.S. Cl. 715/823

(57) ABSTRACT

A method for confirming an action on a display of a computer device includes selecting a button object to initiate the action and utilizing the button object to confirm the action. According to the method of the present invention, an action and its confirmation are enforced within the integral functionality of the same button object.

### FIELD OF THE INVENTION

The present invention relates to a graphical user interface, and more particularly to confirming an action utilizing a single button object.

### BACKGROUND

Devices, such as a personal computer, PDA, or mobile phone, are often networked to resources on a network, such as the Internet, and interact with servers and other computer systems in the network. The servers and other computer systems typically host websites and execute software applications that permit a user of a device to access websites and to perform transactions. Typically, a website can present a variety of options to the user via buttons in a graphical user interface. Each button can be associated with a label that indicates what action will be taken if that button is selected. For example, a button labeled “delete” deletes whatever object is blocked or marked when the button is selected, and a button labeled “save” saves an object.

In some circumstances, after the user has selected, i.e., clicked on, a particular action button, the website will ask the user to confirm that the action button selected is indeed the desired action. This confirmation is typically requested when the user is performing a sensitive task, e.g., transmitting confidential data to the website or deleting a file. In most cases, the website transmits to the user another page, e.g., a confirmation page. In other instances, a separate dialog box asking, “Are you sure?” is utilized to prompt the user to confirm his or her selection. In either case, the user is required to click on a button labeled “yes” to proceed with the action, or a button labeled “cancel” to terminate the action. Depending on the user's choice, the website then proceeds with the transaction.

Here, the action and its confirmation are implemented by two separate button objects on two separate screens/pages or by two separate mechanisms. While functional, such implementation is cumbersome. For example, it is inconvenient for the user because the user must wait for the confirmation page to be displayed and confirm the selection before the action is executed. If the device has a slow connection, e.g., dial-up modem, to the network, this process can require significant time. In addition, a programmer must provide additional and appropriate code to direct the device to the confirmation page, as well as, design and implement the confirmation page. Moreover, the confirmation page is transmitted to the user over the network, which increases traffic on the already overcrowded network.

Furthermore, if a confirmation mechanism requires javascript, such as a pop-up dialog box or the like, such a mechanism can be circumvented by the user, i.e., the can turn javascript off, or may not be correctly supported by the user's browser. In these circumstances, the confirmation mechanism will fail.

Accordingly, what is needed is an improved method for confirming an action through a confirmation button. The method should address and eliminate the disadvantages presented above. The present invention addresses such a need.

### SUMMARY OF THE INVENTION

The present invention provides a method and computer readable medium containing program instructions for confirming an action on a display of a computer device. The method includes selecting a button object to initiate the action and utilizing the button object to confirm the action.

According to the method discussed herein, the present invention enforces button confirmation within the integral functionality of a single object, rather than two separate button objects on separate pages. By integrating button confirmation in such a way, the user can confirm his or her selection in a single page/screen, and network traffic is reduced. Moreover, the programmer needs only to design and implement a single page that integrates the button selection and button confirmation functions, thereby reducing development efforts. Further, because this approach does not rely upon external code, such as JavaScript, to monitor for mouse events, this invention will still function should the user disable JavaScript.

### BRIEF DESCRIPTION OF SEVERAL VIEWS OF THE DRAWINGS

FIG. 1 is a block diagram of a network environment according to a preferred embodiment of the present invention.

FIG. 2 is a flowchart illustrating a process for confirming an action according to a preferred embodiment of the present invention.

FIGS. 3A and 3B are illustrations of an exemplary page/screen displayed to the user according to a preferred embodiment of the present invention.

FIG. 4 is a flowchart illustrating a process for performing an action based on the post selection button according to a preferred embodiment of the present invention.

FIG. 5 is a flowchart illustrating a process for resetting the PS button according to a preferred embodiment of the present invention.

### DETAILED DESCRIPTION OF THE INVENTION

The present invention relates to a graphical user interface, and more particularly to a method for confirming an action utilizing a single button object. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

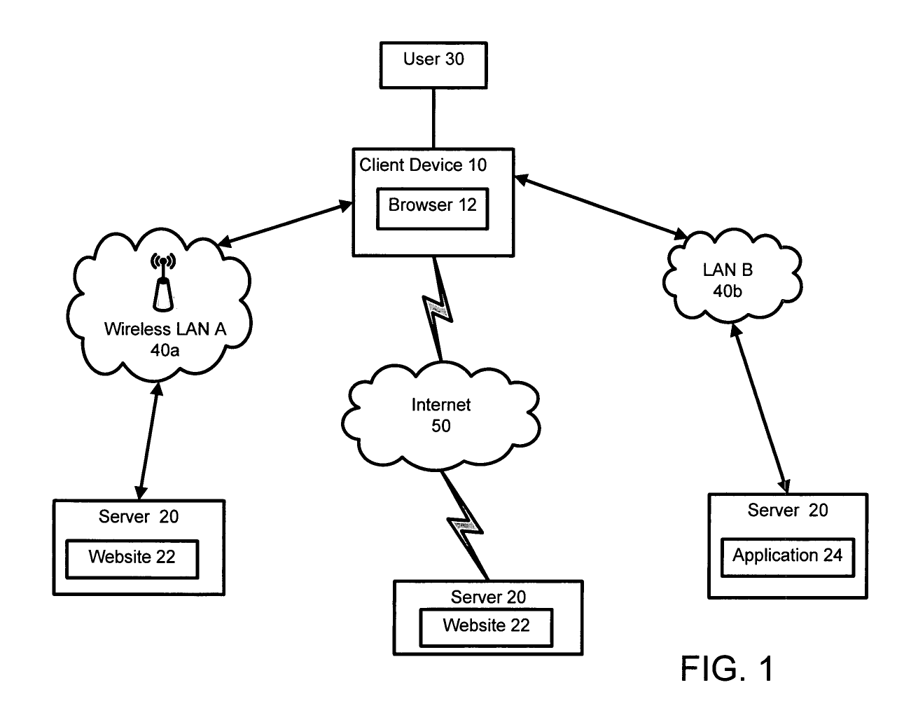

FIG. 1 is a block diagram of a network environment according to a preferred embodiment of the present invention. A client device 10 is coupled to one or more computer systems, e.g., servers 20, through one or more networks, such as a wireless LAN 40a, an Internet 50, and LAN 40b. The client device 10 can be any network enabled computer system, such as a desktop or laptop computer, PDA, or mobile phone. The servers 20 can host websites 22 and/or other applications 24 that can be accessed and utilized by the client device 10, e.g., via its browser 12.

A user 30 of the client device 10 can access a website 22 to perform an action, e.g., to submit financial information in order to purchase an item offered at the website 22. Typically, the website 22 transmits a page (not shown) to the client device 10 that includes a button, which when selected by the user 30 initiates the action, e.g., submission of the information. In response, the website 22 returns a second page requesting the user 30 to confirm the selection by selecting a confirmation button in the second page. After the user 30 confirms the action by selecting the confirmation button, the website 22 then performs the action, e.g., submits the information. Thus, in a conventional system, an action and its confirmation are enforced by two separate button objects on two separate pages/screens. As stated above, this confirmation process is inconvenient to the user 30, to the website programmer, and adversely impacts the network 50.

According to the preferred embodiment of the present invention, an action and its confirmation are implemented within the integral functionality of a single button object on a single page/screen. By integrating the selection and confirmation functionalities into a single object, delays in forwarding a confirmation page are avoided, programming is reduced, and network traffic is decreased.

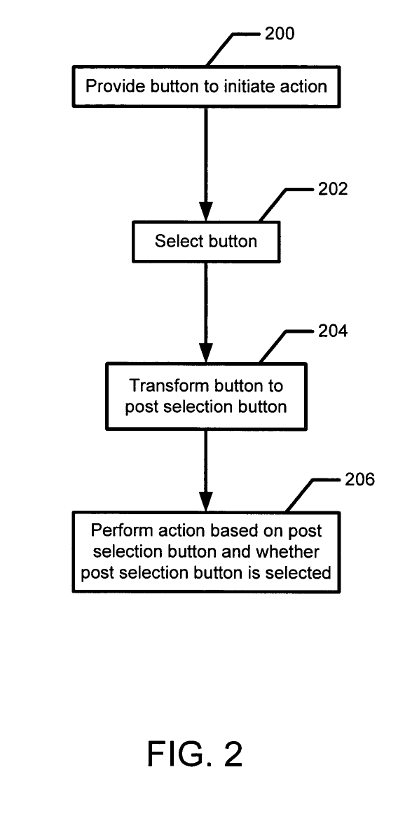

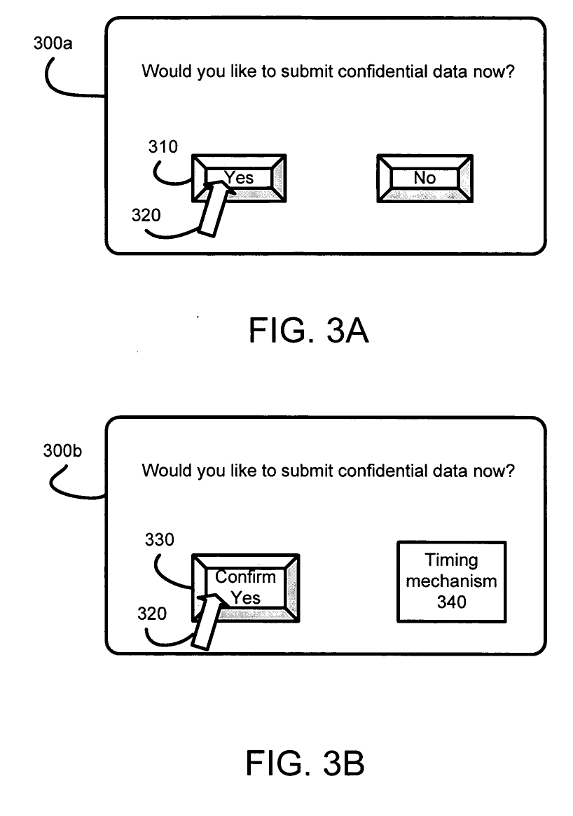

FIG. 2 is a flowchart illustrating a process for confirming an action according to a preferred embodiment of the present invention and FIGS. 3A and 3B are illustrations of an exemplary page/screen displayed to the user. Referring to FIGS. 2, 3A and 3B, the process begins by providing an action button 310 that initiates an action (step 200). The action button 310 can be labeled “Yes” or any other label indicating the user's 30 response or indicating some requested action, such as “submit” or “delete.” The process continues when the user 30 selects the action button 310 (step 202) using, for example, a pointer 320 and clicking a mouse (not shown). In response to such a selection, the action button 310 is transformed into a post selection button 330 (step 204).

The post selection button 330 preferably embodies the confirmation functionality. In other words, the post selection button 330 elicits from the user 30 his or her indication that the selection of the action button 310 is deliberate or accidental. In one preferred embodiment, the post selection button 330 (referred to as “PS button”) is a “confirm” type button, which when selected indicates that the user 30 confirms his or her selection. In another preferred embodiment, the PS button 330 is a “cancel” action type button, which when selected indicates that the user 30 withdraws his or her selection.

The transformation from the action button 310 to the PS button 330 can be instantaneous or it can be gradual. In a preferred embodiment, the transformation is gradual, and during the transformation, the user 30 is not allowed to select the post selection button 330. By gradually transforming the action button 310 into the PS button 330, an over anxious user 30 is forced to pause and consider his or her decision before selecting the PS button 330. Depending on the nature of the PS button 330 and whether the PS button 330 is selected, the action is performed (step 206).

Those skilled in the art readily recognize that numerous variations of graphically representing the confirmation functionality exist, and that the present invention is not limited to those described above. For example, the action button 310 may be graphically represented by a button protected by a “glass” encasement. When selected (step 202), the encased button is transformed into the post selection button 330 (step 204) which is an unprotected button, i.e., the encasement is removed. The action is performed after the unprotected button 330 is selected (step 206).

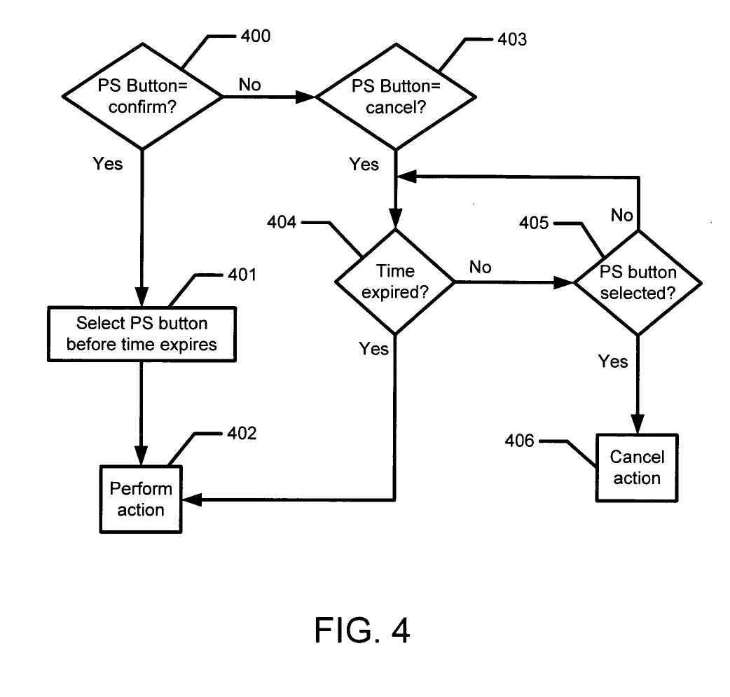

FIG. 4 is a flowchart illustrating a process for performing an action based on the post selection button 330 according to a preferred embodiment of the present invention. Referring to FIGS. 3A, 3B and 4, if the post selection button 330 is a “confirm” type button (step 400), and the user 30 selects the post selection button 330 (step 401), the action is performed (step 402). If the post selection button 330 is a “cancel” type button (step 403) and if the user 30 selects the post selection button 330 (step 405), the action is canceled (step 406).

In a preferred embodiment, an internal timing mechanism 340 is provided that starts a predetermined time period when the user 30 selects the action button 310 (step 202, FIG. 2). Referring again to FIG. 4, if the post selection button 330 is a “cancel” type button (step 403) and the user 30 does not select the post selection button 330 (step 405) before the predetermined time period expires (step 404), the action is performed (step 402). Alternatively, if the post selection button 330 is a “confirm” type button (step 400) and the user 30 selects the PS button 330 before the predetermined time period expires (step 401), the action is performed (step 402). Otherwise, the “confirm” type PS button 330 will reset, which is discussed below.

In another preferred embodiment, the post selection button 330 resets, i.e., reverts back to the action button 310, under certain circumstances. For example, if the PS button 330 is a “confirm” type button, the PS button 330 should be reset if the user 30 does not select the PS button 330 within a predetermined time period or if the user 30 moves the pointer 320 away from the PS button 330.

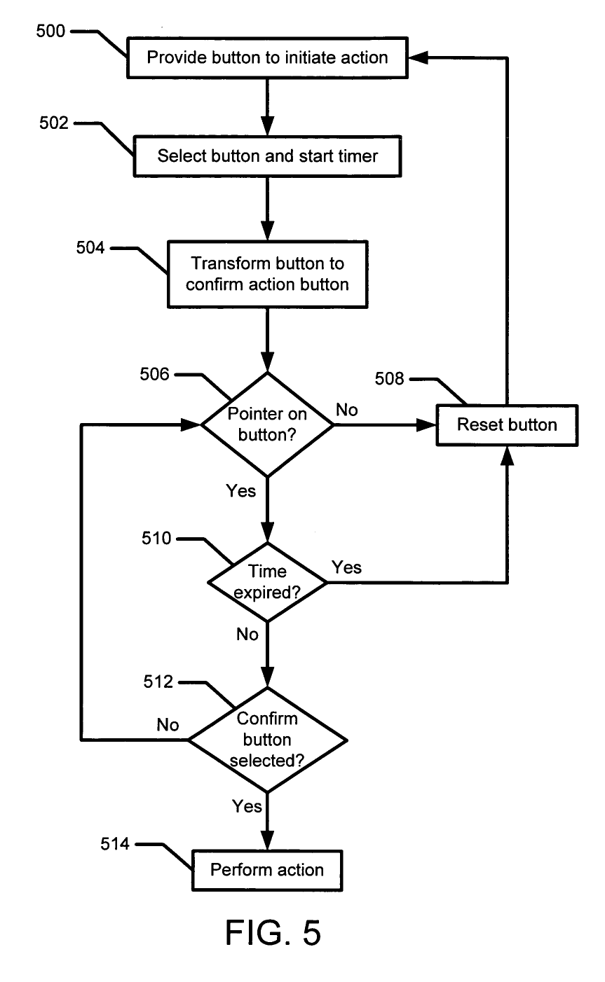

FIG. 5 is a flowchart illustrating a process for resetting the PS button according to a preferred embodiment of the present invention. First, the action button 310 is provided (step 500). The user 30 selects the action button and the internal timing mechanism 340 starts a time period (step 502). The action button 310 then transforms into a “confirm” type button 330 (step 504). Next, if the user 30 moves the pointer 320 away from the PS button 330 (step 506), the PS button 330 will automatically reset itself (step 508) by transforming back into the action button 310 (step 500). From here, the user 30 can decide whether to select the action button 310.

If the pointer remains on the PS button 330 (step 506), then it is determined whether the time period set by the internal timing mechanism 340 has expired (step 510). If the time period has expired, the PS button 330 is reset (step 508). If the time period has not expired, it is determined whether the user 30 has selected the PS button (step 512). If the user has selected the PS button 330, the action is performed (step 514). Otherwise, the process loops back to determine whether the pointer 320 is on the PS button 330 (step 506), and steps 506 through 512 are repeated until the PS button 330 is reset, or the action performed (step 514).

The above described resetting process applies to a “confirm” type PS button. Those skilled in the art would readily appreciate that the process will vary depending on the type of the PS button.

A method for confirming an action via a confirmation button has been presented. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for confirming an action on a display of a computer device, comprising;
selecting a button object to initiate the action; and
utilizing the button object to confirm the action,
whereby the action and its confirmation are enforced within the integral functionality of the same button object.

2. The method of claim 1 further including providing an internal timing mechanism, wherein the internal timing mechanism starts a time period after the button object is selected to initiate the action.

3. The method of claim 2 wherein utilizing the button object includes transforming the button object into a confirm type button.

4. The method of claim 3 wherein utilizing the button further includes selecting the confirm type button.

5. The method of claim 4 further including performing the action after the action is confirmed.

6. The method of claim 3 further including providing a pointing mechanism, wherein the pointing mechanism is utilized to select the button object, and resetting the confirm type button such that the confirm type button is transformed back into the button object if the user moves the pointing mechanism away from the confirm type button.

7. The method of claim 3 further including resetting the confirm type button such that the confirm type button is transformed back into the button object if the user does not select the confirm type button within the time period.

8. The method of claim 2 wherein utilizing the button object includes transforming the button object into a cancel type button.

9. The method of claim 8 further including canceling the action if the cancel type button is selected within the time period.

10. The method of claim 8 further including providing a pointing mechanism, wherein the pointing mechanism is utilized to select the button object, and resetting the cancel type button such that the cancel type button is transformed back into the button object if the user moves the pointing mechanism away from the cancel type button.

11. The method of claim 8 further including performing the action if the time period expires and the cancel type button has not been selected.

12. A computer readable medium containing program instructions for confirming an action on a display of a computer device, comprising;
selecting a button object to initiate the action; and
utilizing the button object to confirm the action,
whereby the action and its confirmation are enforced within the integral functionality of the same button object.

13. The computer readable medium of claim 12 further including providing an internal timing mechanism, wherein the timing mechanism starts a time period after the button object is selected to initiate the action.

14. The computer readable medium of claim 13 wherein utilizing the button object includes transforming the button object into a confirm type button.

15. The computer readable medium of claim 14 wherein utilizing the button further includes selecting the confirm type button.

16. The computer readable medium of claim 15 further including performing the action after the action is confirmed.

17. The computer readable medium of claim 14 further including providing a pointing mechanism, wherein the pointing mechanism utilized to select the button object, and resetting the confirm type button such that the confirm type button is transformed back into the button object if the user moves the pointing mechanism away from the confirm type button.

18. The computer readable medium of claim 14 further including resetting the confirm type button such that the confirm type button is transformed back into the button object if the user does not select the confirm type button within the time period.

19. The computer readable medium of claim 13 wherein utilizing the button object includes transforming the button object into a cancel type button.

20. The computer readable medium of claim 19 further including canceling the action if the cancel type button is selected within the time period.

21. The computer readable medium of claim 19 further including providing a pointing mechanism, wherein the pointing mechanism is utilized to select the button object, and resetting the cancel type button such that the cancel type button is transformed back into the button object if the user moves the pointing mechanism away from the cancel type button.

22. The computer readable medium of claim 19 further including performing the action if the time period expires and the cancel type button has not been selected.
